(19) United States
(12) Patent Application Publication
(10) Pub. No.: US 2003/0048303 A1
(43) Pub. Date: Mar. 13, 2003

(54) Destination direction for push scanning to at least one of multiple destinations

(76) Inventors: Christopher A. Mesa, Meridian, ID (US); Jennifer L. Melin, Boise, ID (US); Kairi Ann Johnston, Star, ID (US); Doug Kaltenecker, Meridian, ID (US); Honee Lee Mesa, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/944,659

(22) Filed: Aug. 31, 2001

(51) Int. Cl. G09G 5/00

(52) U.S. Cl. 345/771

(57) ABSTRACT

An implementation of a technology is described herein for facilitating the direction of push scanning from an input peripheral to one or more destinations of multiple of such possible destinations. With this technology, a user of a scanner quickly and easily performs a “push scan” to a primary target computer of one of multiple targets connected to the scanner (directly or via a network). The user selects a primary target (e.g., a computer) of one of multiple targets connected thereto (directly or via a network) and a secondary target (e.g., a file, an application, an email, a fax, etc.) associated with that primary target. Once selected, the user scans a document at the scanner. The scanner notifies the primary target of the scan request and that it is the intended destination. The primary target initiates and controls the scan. When it receives the scanned data, it directs it to the secondary target. This abstract itself is not intended to limit the scope of this patent. The scope of the present invention is pointed out in the appending claims.

### TECHNICAL FIELD

This invention generally relates to a technology for facilitating the direction of push scanning from an input peripheral to one or more destinations of multiple of such possible destinations.

### BACKGROUND

Sharing of limited resources across a network of computer is one of the primary benefits of such a network. Local Area Networks (LANs), Wide Area Networks (WANs), intranets, and the Internet are common examples of networks of distributed computers sharing resources. Output and input peripherals are common examples of shared resources.

In addition, the availability of flexible direct connections of devices with output and input peripherals is increasing. Such direction connections may be accomplished via any of number of conventional and future mechanisms, such as, for example: Bluetooth, infrared (IR), firewire (IEEE 1394), Universal serial bus (USB), and radio frequency (RF). With these and other conventional connections, an output or input peripheral may have multiple computers directly connected thereto.

A printer is an example of an output peripheral. Printers may be linked to a network via a computer, which acts as a print server, or directly. When linked directly, the printer may act as their own printer server or another computer on the network may act as print servers.

In recent years with the advent of less expensive storage, computers that are more powerful and software, and the introduction of multifunction devices (MFD), the network connection of scanners is becoming more common.

The model for printing across a network (or from one of multiple direct connected computers) is fairly simple and straightforward. A user sends a print job (such as a report) to the printer itself. Alternatively, a user sends a print job (such as a report) to the printer server, which acts as the gatekeeper for the printer, and the server sends the print job to the printer. The printer prints the job. The user walks over to the printer and picks up their printed report.

A scanner is an example of an input peripheral. Scanners may be linked into a network via a computer, which acts as a scan server, or directly. When linked directly, the scanner may act as their own scan server or another computer on the network may act as scan servers.

The model of scanning across a network (or to one of multiple direct connected computers) is not so simple. In a sense, scanning is the opposite of printing. Data is being inputted rather than outputted. Therefore, the resulting scanned data must go somewhere. How does the scanner know which destination to send the data to? In addition, how does the destination know about the incoming scan data and how does it know what to do with it?

Existing technique for scanner-to-destination event communication involve polling and sending simple button-press notifications. However, polling is inefficient because it uses the communication bandwidth constantly rather than only when needed. There was also a tradeoff between responsiveness and increased bandwidth use because a prompt response to the user would require frequent polling, which made other communication, such as scanning or printing, take longer.

Another approach has involved adapting the scanner to allow the user to select the network destination (or one of multiple direct connected destinations), and then sending the input data directly to that destination. A problem involved with this approach was that the destination often needed to perform various setup steps before it was ready to receive the data. Furthermore, it often needed additional user input to route the data to the desired target of that destination. In other words, the destination needed to know what to do with the resulting scanned data once it received it. Although the scanned data could be received at the destination, the user was still required to input data in two different places.

In another approach, the scan could be performed at the scanner, but this required the scanner to know all possible actions that the destination might want to take with the data, which made it very difficult to add new functions to software of the destination because of the necessity to change the scanner at the same time.

### SUMMARY

Described herein is a technology for facilitating the direction of push scanning from an input peripheral to one or more destinations of multiple of such possible destinations.

With this technology, a user of a scanner quickly and easily performs a “push scan” to a primary target computer of one of multiple targets connected to the scanner (directly or via a network). The user selects a primary target (e.g., a computer) of one of multiple targets connected thereto (directly or via a network) and a secondary target (e.g., a file, an application, an email, a fax, etc.) associated with that primary target. Once selected, the user scans a document at the scanner. The scanner notifies the primary target of the scan request and that it is the intended destination. The primary target initiates and controls the scan. When it receives the scanned data, it directs it to the secondary target.

This summary itself is not intended to limit the scope of this patent. Moreover, the title of this patent is not intended to limit the scope of this patent. For a better understanding of the present invention, please see the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is a block diagram showing network connected input peripheral and network destinations in accordance with an implementation described herein.

FIG. 2 is a flow chart illustrating a methodological implementation in accordance with an embodiment described herein.

FIG. 3 is a flow chart illustrating a methodological implementation in accordance with an embodiment described herein.

FIG. 4 is an example of a computing operating environment capable of implementing an embodiment (wholly or partially) described herein or capable of being a primary target of an embodiment (wholly or partially) described herein.

### DETAILED DESCRIPTION

In the following description, for purposes of explanation, specific numbers, materials and configurations are set forth in order to provide a thorough understanding of the present invention. However, it will be apparent to one skilled in the art that the present invention may be practiced without the specific exemplary details. In other instances, well-known features are omitted or simplified to clarify the description of the exemplary implementations of the present invention, thereby better explaining the present invention. Furthermore, for ease of understanding, certain method steps are delineated as separate steps; however, these separately delineated steps should not be construed as necessarily order dependent in their performance.

The following description sets forth one or more exemplary implementations of a Destination Direction for Push Scanning to at least one of Multiple Destinations. The inventors intend these exemplary implementations to be examples. The inventors do not intend these exemplary implementations to limit the scope of the claimed present invention. Rather, the inventors have contemplated that the claimed present invention might also be embodied and implemented in other ways, in conjunction with other present or future technologies.

An example of an embodiment of a Destination Direction for Push Scanning to at least one of Multiple Destinations may be referred to as an “exemplary kick-pull scan destination director.”

### Introduction

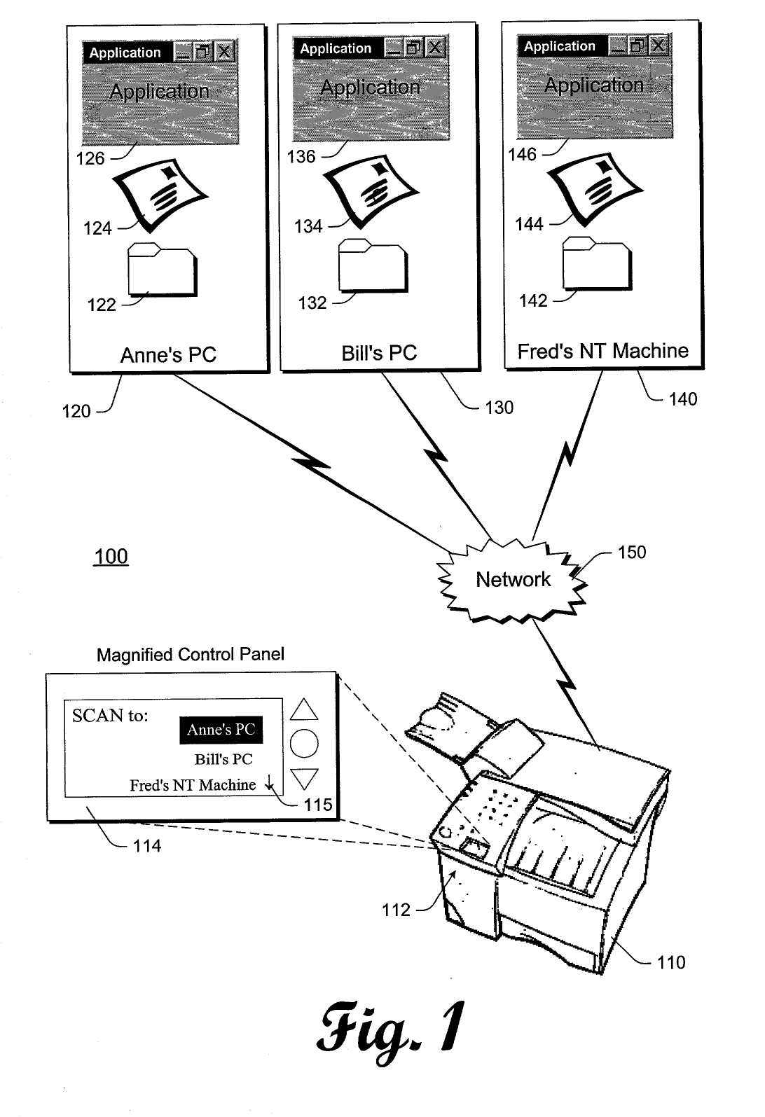

The one or more exemplary implementations, described herein, of the present claimed invention may be implemented (in whole or in part) by a kick-pull scan destination direction system 100 and/or by a multifunction peripheral (MFP) 110 (or other scanning device). At least one implementation of the exemplary kick-pull scan destination director is the MFP 110 shown in FIG. 1 or some portion thereof.

With the exemplary kick-pull scan destination director, a user of a scanner quickly and easily performs a “push scan” to a primary target computer of one of multiple targets connected to the scanner (directly or via a network). The user selects a primary target (e.g., a computer) of one of multiple targets connected thereto (directly or via a network) and a secondary target (e.g., a file, an application, an email, a fax, etc.) associated with that primary target. Once selected, the user scans a document at the scanner. The scanner notifies (i.e., the “kick”) the primary target of the scan request and that it is the intended destination. The primary target initiates and controls (i.e., the “pull”) the scan. When it receives the scanned data, it directs it to the secondary target. For example, the scanned data may be directed to a fax application for facsimile transmission.

Herein, the “primary target” may also be called the “host.” Typically, it is a computer connected to a scanner (or MFP) via a network or directly. It is also typically one of multiple such computers connected to the scanner (or MFP). One or more of such connected computers may be a potential primary target.

Herein, the “secondary targets” are resources associated with the primary target. They are the ultimate destination for the scanned data. Typically, it is a location to which to data is transmitted, a location to store the data, or an application to receive the data. By way of example (and not limitation), it may be a file and path name to store the data on a physical medium, it may be a fax number to transmit the data, it may be an application (e.g., a word processor) to open and drop the data into, and it may be an email address to send the data to.

Herein, a “push scan” from a “scanner” to one of multiple connected hosts is a specific form of the more generic “push input” from an “input peripheral.” Furthermore, a “kick-pull scan” from a “scanner” to one of multiple connected hosts is a specific form of the more generic “kick-pull input” from an “input peripheral.”

### Push Scanning

In general, a “push scan” may occur when a user initiates a scan from a scanner so the data gets pushed from the scanner to a destination, such as a network-connected computer. There are at least two ways this may be implemented:

1. The scanner may open the input/output (I/O) channel, initiate communication with the destination and start scanning; or

2. The scanner notifies the destination computer of the user wanting to complete a scan. The destination computer then opens the I/O channel, initiates communication and requests the scanner to start the scan job.

With either approach, it looks to the user like the scanner is “pushing” the scan data to the host. However, in the latter of the above two “push scan” approaches, the destination computer is “pulling” the data from the scanner. That approach is more precisely known as the “kick-pull” approach. The “kick” is the scanner notification of the destination computer of the user wanting to complete a scan. The “pull” is the destination computer opening the I/O channel and initiating communication and requests the scanner to start the scan job.

Many conventional scanners allow a user to initiate a scan at the scanner and send the data to a directly connected host. However, a few scanners on the market provide a way for the user to employ push scanning over a network or on shared devices. Of those, some support network scans but all scans are sent to a designated server. In that situation, a user must then retrieve the data from the server after scanning something at the scanner. This requires host software be installed onto a server that every user has access to.

Other devices (such as Hewlett Packard's Digital Sender) require a user to enter a computer's network address (e.g., an email address) at the scanner before sending the data. A computer's network address is not always the most convenient to remember. Furthermore, the device must have complicated and expensive logic and storage to manage multiple addresses and transmit across a network using network protocol. Sometimes, such devices employ the sophistication of a network server to perform these tasks.

### Exemplary Kick-Pull Scan Destination Director

FIG. 1 shows kick-pull scan destination direction system 100, which includes a MFP 110 and multiple hosts 120, 130, 140 connected to the MFP via a network 150.

The network 150 may be a LAN or WAN. It may be the Internet. It may be, instead, multiple direct-connections between the MFP 110 and the hosts 120, 130, 140. Such direction connections may be accomplished via any of number of conventional and future mechanisms, such as, for example: Bluetooth, infrared (IR), firewire (IEEE 1394), Universal serial bus (USB), and radio frequency (RF).

FIG. 1 shows three hosts (e.g., computers): “Anne's PC” 120, “Bill's PC” 130, and “Fred's NT Machine” 140. These labels are the hosts names or identifications, which may be called their “host ids.” Herein, any of these hosts may be a primary target for a push scan from the MFP 110. More specifically, any of these hosts may be a primary target for a kick-pull scan from the MFP 110.

Each of these hosts has one or more secondary targets. These are specific destinations on the hosts from the incoming scanned data. “Anne's PC” 120 has file 122, email 124, and application 126. “Bill's PC” 130 has file 132, email 134, and application 136. “Fred's NT Machine” 140 has file 142, email 144, and application 146. Examples of applications include a word processor, an image processor, and a character recognition program.

On the MFP 110, there is typically a control panel 112. A magnification of the display portion of the control panel is shown at 114. The user of the MFP is presented with the option to select which host to “scan the document to.” (The quotes here indicate that the apparent push scan may be a kick-pull scan instead.) The user may, for example, select “Anne's PC” on the display. That is host 120 of FIG. 1.

An indicator (such as a down arrow 115) means that more hosts are in the list. When the user wants to jump to a specific name in the list, the user may select a character on the display for the first character of the host id. The display will then jump to the location in the list where the host id's start with the character. For the MFP 110 control panel, the user may use the number pad.

The display may, for example, show more specific listings such as:

Anne's PC:Email

Anne's PC:AppName

Bill's PC:Fax

Bill's PC:FileName

Fred's NT Machine:AppName

In these examples, the text prior the colon (“:”) indicates the primary target (i.e., the host). The text following the colon indicates the secondary target (e.g., the name of the application to receive the data, the name of the file to store the data, etc.). Alternatively, the options may be displayed in the step-through type hierarchy. In such a scenario, after the user selects a primary target, a list of secondary targets associated with that primary target is displayed. The user may select the secondary target from that list.

No existing push scan technology allows the user to specify both a primary and a secondary target. Furthermore, no existing kick-pull scan technology allows the user to specify both a primary and a secondary target

### Methodological Implementations of Exemplary Kick-Pull Scan Destination Director

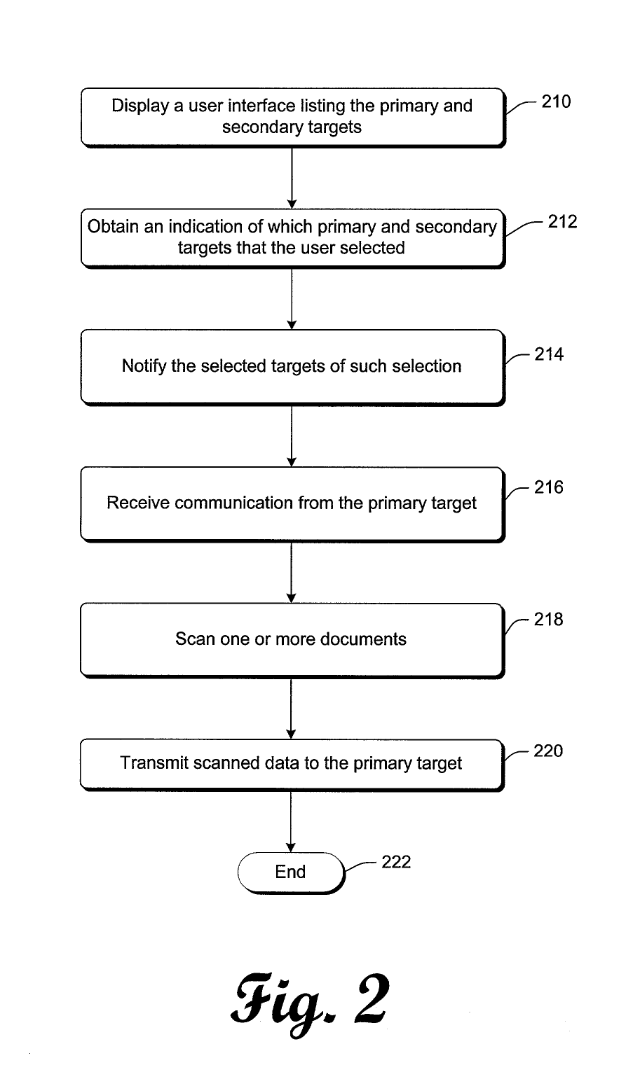

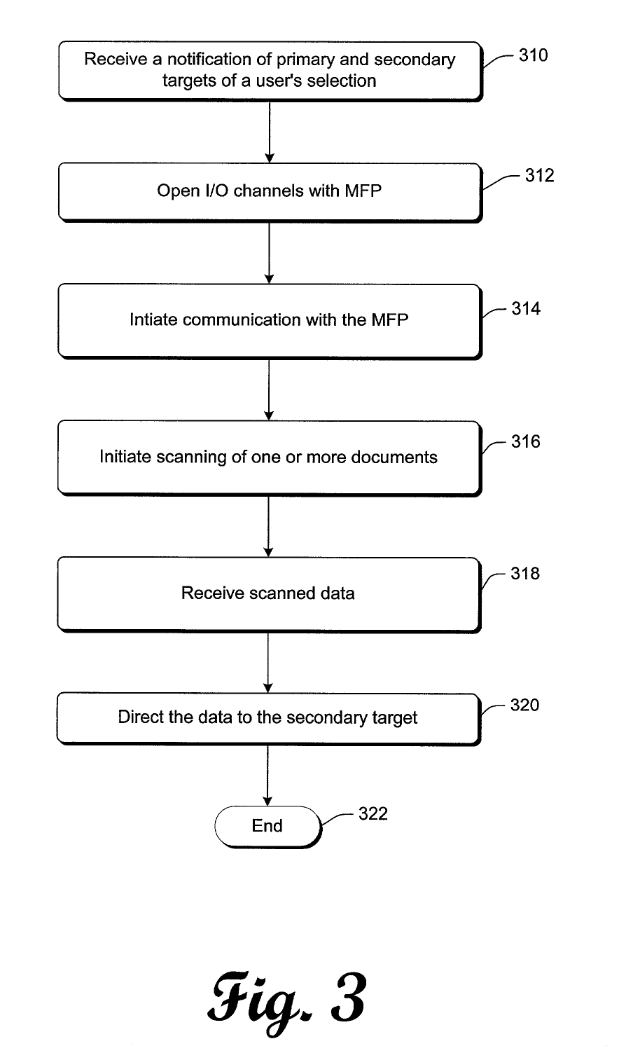

FIGS. 2 and 3 shows methodological implementations of the exemplary kick-pull scan destination director performed by the kick-pull scan destination direction system 100 (or some portion thereof). This methodological implementation may be performed in software, hardware, or a combination thereof.

At 210 of FIG. 2, the MFP 110 displays a user interface (UI) listing the primary and secondary targets. This may be accomplished via a control panel like that shown at 112. At 212, the MFP obtains an indication of which primary and secondary targets that the user selected.

At 214, the MFP notifies the host that has been selected. Thus, it sends a notification indicating the selected primary and secondary targets. Notifications may be sent using an underlying messaging protocol, such as the Peripheral Management Language (PML) protocol. Blocks 210-214 illustrate the “kick” in part or in whole.

At 216, the MFP receives communication from the primary target. Typically, this communication will initiate the MFP to scan. At 218, the MFP scans one or more original documents. At 220, the MFP transmits the scanned data to the primary target. Blocks 216-220 illustrate the “pull” in part or in whole.

The process ends at 222.

At 310 of FIG. 3, host computer (e.g., computer 120 of FIG. 1) receives a notification of the selected primary and secondary targets from the MFP. Block 310 illustrates the “kick” in part or in whole.

At 312, the computer opens an input/output (I/O) channel with the MFP. At 314, the computer initiates communications with the MFP. At 316, the communications directs the MFP to scan one or more original documents. At 318, the computer receives the scanned data from the MFP. At 320, the computer directs the data to the secondary target. Blocks 312-320 illustrate the “pull” in part or in whole.

The process ends at 322.

### Other Implementation Details

The MFP 110 knows of the existence of the multiple hosts (primary targets) and their associated secondary targets via a registration process. The host may register for a push scan at installation, power-up or during run-time. The following table explains how the host may register for a push scan dynamically in all scenarios. An assumption is made that the MFP is already running. If the device is not running or the host is not able to communicate with the MFP, the host may display an error to the user.

When the host registers with the MFP, the host typically provides the MFP with:

Host id (e.g., Bill's PC)

Technical name (e.g., ip address, channel)

TABLE 1
“REGISTRATION Table”

| Time | Connection | No control panel display | Control panel display |
|---|---|---|---|
| Host SW | Direct | HOST: The host may | HOST: The host may automatically |
| Installation | Connections | automatically register with | register with the MFP for a push |
| | (single or | the MFP for a push scan. | scan. |
| | more) | MFP: The MFP limits only | MFP: The MFP with a display does |
| | | one host registered for a push | not have a specified limit on the |
| | | scan when the MFP does not | number of hosts registered for a |
| | | have a display. | push scan (there is probably some |
| | | If no other host has registered | limit based on memory). However, |
| | | for a push scan, the device | there are some checks that the |
| | | keeps the host's information | device must do: |
| | | for sending notification when | Check if the host id already exists. |
| | | the ‘scan’ button is pressed. | If so return an error to the host. |
| | | Check if the technical id of | (Unique host id's must be displayed |
| | | the host exists (this id is used | to the user on the control panel |
| | | to know which host to send | display). |
| | | notification of a push scan | Check if the technical id of the host |
| | | to). If the technical id | exists (this id is used to know which |
| | | already exists, overwrite the | host to send notification of a push |
| | | old host id with the new one. | scan to). If the technical id already |
| | | Each host only has one entry | exists, overwrite the old host id with |
| | | in the display list, | the new one. Each host only has |
| | | If another host has already | one entry in the display list. |
| | | registered for a push scan, | |
| | | the device returns an error to | |
| | | the host. | |
| | Networked | HOST: The host does NOT | HOST: The host does NOT |
| | | automatically register with a | automatically register with a |
| | | networked device. The user | networked device. The user is able |
| | | is able to go into software | to go into the software (SW)at |
| | | (SW) at anytime and register | anytime and register for push |
| | | for push scanning. The first | scanning. This will limit the list of |
| | | time the user tries to access | registered hosts on the display. The |
| | | the SW, a message will be | first time the user tries to access the |
| | | displayed to the user to | SW, a message will be displayed to |
| | | explain to them the use of | the user to explain to them the use |
| | | push scanning and how to | of push scanning and how to |
| | | register. | register. |
| Host Power | Direct | HOST: The host SW will | HOST: The host SW will keep |
| - Up/User | Connections | keep knowledge of the user's | knowledge of the user's profile, |
| login | (single or | profile, such as if the user | such as if the user registered for a |
| | more) | registered for a push scan and | push scan and the host id provided. |
| | | the host id provided. Every | Every time the user logs into their |
| | | time the user logs into their | PC, their environment is restored |
| | | PC, their environment is | and the host will register with the |
| | | restored and the host will | device for a push scan, using the last |
| | | register with the device for a | entered host id. |
| | | push scan, using the last | MFP: same steps as during host |
| | | entered host id. | installation. |
| | | MFP: same steps as during | |
| | | host installation. | |
| | Networked | Same as in a direct | Same as in a direct connection. |
| | | connection. | |
| Host Run- | Direct | HOST: At anytime, the user | HOST: At anytime, the user can |
| Time | Connections | can change their registration | change their registration for push |
| | (single or | for push scanning. | scanning. |
| | more) | Register for push scanning | Register for push scanning |
| | | Unregister for push scanning | Unregister for push scanning (the |
| | | (the device will check if the | device will check if the registration |
| | | registration id exists and | id exists and removes it from the list |
| | | removes it from the list of | of registered hosts) |
| | | registered hosts) | Change Host id name, which is |
| | | Change Host id name | shown on the control panel display |
| | | MFP: same steps as during | MFP: same steps as during the host |
| | | the host installation. | installation. |
| | Networked | Same as in a direct | Same as in a direct connection. |
| | | connection. | |
| Host | Direct | HOST: If the host is | HOST:: If the host is registered for |
| shutdown/ | Connections | registered for a push scan, | a push scan, the host SW will |
| User logs | (single or | the host SW will | automatically unregister with the |
| off | more) | automatically unregister with | device for a push scan. The host will |
| | | the device for a push scan. | also add the push scan registration |
| | | The host will also add the | to the user's profile. When the user |
| | | push scan registration to the | logs back in, the host will be |
| | | user's profile. When the user | registered for a push scan again |
| | | logs back in, the host will be | using the user's profile. |
| | | registered for a push scan | MFP: The device will check if the |
| | | again using the user's profile. | host id is in its registered list of |
| | | MFP: The device will check | hosts and remove the hosts |
| | | if the host id is in its | registration. |
| | | registered list of hosts and | |
| | | remove the hosts registration. | |
| | Networked | Same as in a direct | Same as in a direct connection. |
| | | connection. | |

When a host is registered for a push scan and the user presses the ‘scan’ button on the MFP, the following results may occur.

TABLE 2
“Result from a ‘scan’ button press”

| # of Host's registered | No control panel display | Control panel display |
|---|---|---|
| Single Host | The originals in the scanner are | The originals in the scanner are |
| | scanned to the host. allowing a | scanned to the host, allowing a |
| | single button press scan to host | single button press scan to host |
| | job. | job. The display shows |
| | | “Scanning to <host id>” |
| Two or more Hosts | N/A | The list of host id's may be |
| | | alphabetically shown on the |
| | | display. The user can scroll |
| | | through the list and select the |
| | | host id to scan to. Once the |
| | | destination is selected, the |
| | | originals in the scanner are |
| | | scanned to the host and the |
| | | display shows “Scanning to |
| | | <host id>” |

The list maintained on the MFP may have the following features:

It is dynamic—hosts register and un-register as necessary so the list does not get outdated or require MIS maintenance. At any point in time, the MFP list holds only hosts that are available to receive the scan notification. If a host is shutting down, it un-registers itself from the device so will not appear any more!

Contains both a common name/host id and technical name—The common name is displayed to the user to allow easy recognition of hosts. The technical name includes whatever information the device needs to communicate with the host but is not displayed to the user.

May or may not be stored though a power cycle—If not, some sort of recovery needs to be implemented in the host.

With the kick-pull model, the user can select which host to scan to from the device and then the device may notify the host through the UI_SELECT_OPTION PML object. The host will then start scan to host job.

When the host registers for a push scan, the host is registering for a ‘scan’ button press. When the host receives notification of the button press, the host software (SW) will complete the task that the user has set the SW to do. When this button is pressed, the SW may start a scan job or bring up a word processor for instance.

NETWORK Push Scanning

The following explains the steps between SW, firmware (FW) and a network connection box (such as the JetDirect EX box) to complete a push scan.

The network connection box may support the UI_SELECT_OPTION PML object. FW supports UI_SELECT_OPTION, UI_ADD_OPTION and UI_DELETE_OPTION PML objects. SW supports UI_SELECT_OPTION, UI_ADD_OPTION and UI_DELETE_OPTION PML objects.

At initialization, the network connection box automatically trap on the UI_SELECT_OPTION in the device/FW. When the user selects to complete a push scan at the device, the device sets the UI_SELECT_OPTION object:

the MFP sends the trap notification to the network connection box. This notification includes all data fields that were passed with the UI-ADD-OPTION object:

Type=Scan, Fax Receive, etc (so specifies which event occurred, thus the host will NOT need to query back after receiving the notification);

Display String=“Tom's PC” that can be used to display on the control panel for the push scanning;

NetAddr=the network address of who to send the notification—this is the only required data for the network connection box in the notification (the rest of the data fields just need to be understood between the host software and the device).

the network connection box will parse out the NetAddr in the response and forward that host a UDP_Datagram containing the response information.

the host is expected to send back a copy of the UDP_Datagram to the network connection box as a confirmation that it received it. The network connection box will re-send the UDP_Datagram if it does not get the response in some time frame (up to about 4 times).

the host then responds as it wants (it already knows the type so does not need to query the device)

DIRECT Connection Push Scanning

At Startup:

send a UI_ADD_OPTION to add self to MFP push scan list

trap on the UI_SELECT_OPTION (the I/O layer will determine whether to setup the UDP_DATAGRAM ‘listener’ if on network or actually trap on the object in a direct connect case)

When a response comes back:

parse the response to determine the type and perform the appropriate action

At Shutdown:

Un trap on the UI_SELECT_OPTION

send a UI_DELETE_OPTION

### Alternative Implementations

Increased Security—If the user selects a destination from the menu list, the user would be required to enter a pin number to continue with the scan job. If the pin number was not valid, the scan job would be cancelled.

User can register and unregister for push scans at the device, by entering a host id,technical name of the host and password if the security option is used.

Change Scan settings at the MFP—The MFP may prompt the user for different job settings to use for the scan.

MFP initiated scans—The MFP may open an I/O channel and initiating communication with the host to actually push the scan data back.

The MFP could unregister hosts. The MFP may periodically poll to determine if it can still communicate with a host. If it cannot communicate with the host, the MFP may remove the host id from its registered list of destinations to scan to.

If the MFP has IR and IR connection is made, the IR destination will be placed at the top of the list of scan destinations. This will provide any easy walk up use model.

### Exemplary Computer Architecture

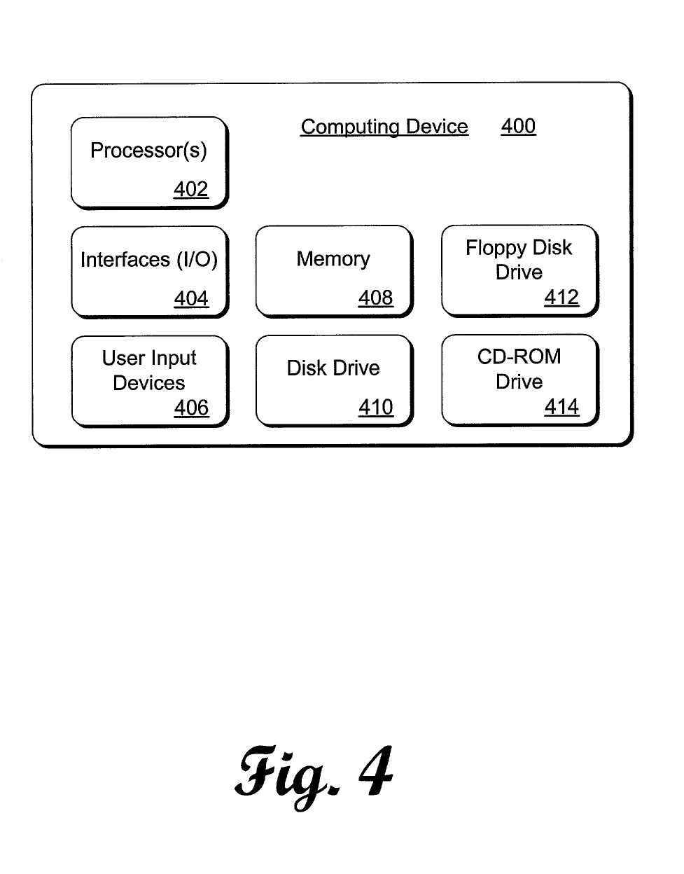

FIG. 4 illustrates various components of an exemplary computing device 400 that may be utilized to implement a portion of the exemplary kick-pull scan destination director. Computer 400 includes one or more processors 402, interfaces 404 for inputting and outputting data, and user input devices 406. Processor(s) 402 process various instructions to control the operation of computer 400, while interfaces 404 provide a mechanism for computer 400 to communicate with other electronic and computing devices. User input devices 406 include a keyboard, mouse, pointing device, or other mechanisms for interacting with, and inputting information to computer 400.

Computer 400 also includes memory 408 (such as ROM and/or RAM), a disk drive 410, a floppy disk drive 412, and a CD-ROM drive 414. Memory 408, disk drive 410, floppy disk drive 412, and CD-ROM drive 414 provide data storage mechanisms for computer 400. Although not shown, a system bus typically connects the various components within the computing device 400.

### CONCLUSION

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for facilitating the pushing of input data across one or more communications links from an input peripheral to one or more multiple hosts, the method comprising:
displaying a user interface (UI) from which one or more destinations of inputted data may be selected, wherein a destination comprise one or more multiple hosts;
obtaining an indication of a selected destination;
notifying a host of the selected destination;
receiving communications from the host;
inputting data at the input peripheral;
transmitting the inputted data to the selected destination host.

2. A method as recited in claim 1, wherein the input peripheral is selected from a group consisting of a scanner and a multifunction peripheral (MFP).

3. A method as recited in claim 1, wherein the one or more multiple hosts are computers.

4. A method as recited in claim 1, wherein the inputted data is image data resulting from scanning one or more documents.

5. A method as recited in claim 1, wherein the communications link is selected from groups consisting of a network and multiple direct-connections.

6. A method as recited in claim 1, wherein a destination comprises a primary target and a secondary target, the primary target comprising one or more multiple hosts and the secondary target comprising resources associated with the primary target.

7. A method as recited in claim 1, wherein a destination comprises a primary target and a secondary target, the primary target comprising one or more multiple hosts and the secondary target comprising resources associated with the primary target, the method further comprising providing a selection mechanism via the UI where a user may select both a primary and a secondary target.

8. A method as recited in claim 1, wherein a destination comprises a primary target and a secondary target, the primary target comprising one or more multiple hosts and the secondary target comprising resources associated with the primary target, the method further comprising providing a selection mechanism via the UI where a user may select a primary target via a first menu and then a secondary target associated with the selected primary target.

9. A method as recited in claim 1, wherein a destination comprises a primary target and a secondary target, the primary target comprising one or more multiple hosts and the secondary target comprising resources associated with the primary target, wherein such resources are selected from a group consisting of:
an application program for receiving the inputted data;
a telephone number for facsimile transmission of the inputted data
an email address to send the inputted data to;
storage location to store the inputted data.

10. A method for facilitating “kick-pull” scanning across one or more communications links from an input peripheral to one or more multiple hosts, the method comprising:
displaying a user interface (UI) from which one or more destinations of inputted data may be selected, wherein a destination comprises a primary target and a secondary target, the primary target comprising one or more multiple hosts and the secondary target comprising resources associated with the primary target;
obtaining an indication of a selected destination;
inputting data at the input peripheral;
transmitting the inputted data to the selected destination.

11. A method as recited in claim 10, further comprising:
notifying a host of the selected destination;
receiving communications from the host.

12. A method as recited in claim 10, wherein the input peripheral is selected from a group consisting of a scanner and a multifunction peripheral (MFP).

13. A method as recited in claim 10, wherein the one or more multiple hosts are computers.

14. A method as recited in claim 10, wherein the inputted data is image data resulting from scanning one or more documents.

15. A method as recited in claim 10, wherein the communications link is selected from groups consisting of a network and multiple direct-connections.

16. A method as recited in claim 10, further comprising providing a selection mechanism via the UI where a user may select both a primary and a secondary target.

17. A method as recited in claim 10, further comprising providing a selection mechanism via the UI where a user may select a primary target via a first menu and then a secondary target associated with the selected primary target.

18. A method as recited in claim 10, wherein the resources are selected from a group consisting of:
an application program for receiving the inputted data;
a telephone number for facsimile transmission of the inputted data
an email address to send the inputted data to;
storage location to store the inputted data.

19. A computer-readable medium having computer-executable instructions that, when executed by a computer, performs a method for facilitating “kick-pull” scanning across one or more communications links from an input peripheral to one or more multiple hosts, the method comprising:
receiving a notification of a selected destination from the input peripheral, wherein the selected destination comprises a primary target and a secondary target, the primary target comprises one or more multiple hosts and receives this notification and the secondary target comprising resources associated with the primary target;
communicating with the input peripheral;
receiving inputted data from the input peripheral;
directing the inputted data to the secondary target.

20. A method as recited in claim 19, wherein the input peripheral is selected from a group consisting of a scanner and a multifunction peripheral (MFP).

21. A method as recited in claim 19, wherein the inputted data is image data resulting from scanning one or more documents.

22. A method as recited in claim 19, wherein the resources are selected from a group consisting of:
an application program for receiving the inputted data;
a telephone number for facsimile transmission of the inputted data
an email address to send the inputted data to;
storage location to store the inputted data.
